(19) United States
(12) Patent Application Publication
(10) Pub. No.: US 2016/0221315 A1
(43) Pub. Date: Aug. 4, 2016

(54) LAMINATE FILM AND MANUFACTURING METHOD THEREOF, TOUCH PANEL DEVICE, IMAGE DISPLAY DEVICE, AND MOBILE DEVICE

(71) Applicant: MITSUBISHI RAYON CO., LTD., Tokyo (JP)

(72) Inventor: Atsushi SAIKI, Otake-shi (JP)

(73) Assignee: Mitsubishi Rayon Co., Ltd., Chiyoda-ku (JP)

(21) Appl. No.: 15/021,034

(22) PCT Filed: Sep. 17, 2014
(86) PCT No.: PCT/JP2014/074535

§ 371 Date: Mar. 10, 2016

(30) Foreign Application Priority Data
Sep. 18, 2013 (JP) 2013-192971

(51) Int. Cl. B32B 27/36; G06F 3/041; B32B 7/06

(52) U.S. Cl. CPC B32B 27/36; B32B 7/06; G06F 3/041; B32B 2255/10; B32B 2255/20; B32B 2255/26; B32B 2307/202; B32B 2307/418; B32B 2307/412; B32B 2457/208; G06F 2203/04103

(57) ABSTRACT

This laminate film used in a touch panel device is provided with a substrate, a refractive index adjusting layer which is provided on the first side of the substrate, a transparent conductive layer provided on the side of the refractive index adjustment layer opposite the substrate, and a fine uneven structure layer provided on the second side of the substrate, wherein the fine uneven structure layer has a fine uneven structure in which the average interval between protrusions and recesses on the surface is 400 nm or less, and is provided on the second surface of the substrate such that the surface opposite of the surface having the fine uneven structure faces towards the substrate.

### TECHNICAL FIELD

The present invention relates to a laminate film and a manufacturing method thereof, a touch panel device, an image display device, and a mobile device.

This application is based upon and claims the benefit of priority of the prior Japanese Patent Application No. 2013-192971 filed in Japan on Sep. 18, 2013, the entire contents of which are incorporated herein by reference.

### BACKGROUND ART

In recent years, the opportunity for multimedia viewing using a monitor device, a mobile device, and the like has increased, and the demand for the monitor device, the mobile device, and the like has also increased. The image display device such as a liquid crystal device is required to have a high resolution and to consume a low electric power. A transparent conductive element (transparent conductive film) having a transparent conductive layer provided on a transparent substrate with a flat surface is usually used in the touch panel device used in an image display device. The transparent conductive element is significantly useful as a transparent electrode of a display device such as a liquid crystal display, a plasma display, or an organic EL display, a photovoltaic cell, a touch panel, and the like and as a transparent conductive film of an electromagnetic wave shielding material and the like to be widely utilized.

A glass substrate is general as the transparent substrate used in the touch panel device, but a resin substrate such as a polycarbonate substrate or a polyethylene terephthalate substrate is used in recent years for the purpose of reducing the weight of the touch panel device or of preventing the glass substrate from being cracked (see Patent Document 1).

However, the resin substrate has a higher flexibility as compared to a glass substrate, and there is a problem that the resin substrate of a touch panel device comes in contact with the display element of an image display device when the touch panel device is pressed and thus Newton's rings are caused around the contact part or the display element and the resin substrate are stuck (blocked) to each other to deteriorate the visibility of the image display device.

In order to solve the above problem, it is attempted that the surface of the transparent substrate used in the touch panel device is roughened or fine particles are contained in the transparent substrate.

However, the image is likely to be unclear as the image display device fades or has increased haze when the surface of the transparent substrate is roughened or fine particles are contained in the transparent substrate.

In addition, upon manufacturing a touch panel device, first, the respective members (for example, a plurality of transparent conductive films) constituting the touch panel device are laminated to form a film laminate, and a peelable protective film is then further laminated on the outermost layer of the film laminate. Subsequently, the film laminate having the protective film laminated thereon is disposed in a heat-resistant and pressure-resistant air tight container and subjected to a pressure degassing treatment by applying a pressure thereto so as to remove the air bubbles in between the members.

However, air bubbles are generated in between the protective film and the film laminate by the pressure degassing treatment, and thus it is difficult to inspect whether the air bubbles in between the members constituting the touch panel device are removed or not in some cases.

DOCUMENTS OF RELATED ART

### Patent Documents

Patent Document 1: JP 2013-22843 A

### SUMMARY OF THE INVENTION

### Problem to be Solved by the Invention

The invention has been made in view of the above circumstances, and an object of the invention is to provide a laminate film for a touch panel device which is excellent in resistance to blocking and resistance to Newton's rings and by which a clear image can be obtained, a manufacturing method thereof, a touch panel device, an image display device, and a mobile device.

In addition, another object of the invention is to provide a laminate film by which air bubbles are hardly generated between a protective film and a laminate film even when the laminate film having the protective film laminated thereon is subjected to a pressure degassing treatment and a touch panel device and an image display device which have high quality can be more simply obtained, a manufacturing method thereof, a touch panel device, an image display device, and a mobile device.

### Means to Solve the Problems

The invention has the following aspects.

<1> A laminate film used in a touch panel device, the laminate film including:

a substrate;

a refractive index adjusting layer provided on a first surface of the substrate;

a transparent conductive layer provided on a surface on the opposite side to the substrate of the refractive index adjusting layer; and

a fine concavo-convex structure layer provided on a second surface of the substrate, in which

the fine concavo-convex structure layer has a fine concavo-convex structure having an average interval between convexities or concavities of 400 nm or less on a surface and is provided on the second surface of the substrate such that a surface on the opposite side to the surface on a side having the fine concavo-convex structure faces a substrate side.

<2> The laminate film according to <1>, in which the substrate is a polyethylene terephthalate substrate.

<3> The laminate film according to <1> or <2>, in which the refractive index adjusting layer has a laminate structure equipped with one or more layers of a high refractive index layer having a higher refractive index than the substrate and one or more layers of a low refractive index layer having a lower refractive index than the high refractive index layer.

<4> The laminate film according to any one of <1> to <3>, further including a hard coat layer between the substrate and the refractive index adjusting layer.

<5> The laminate film according to any one of <1> to <4>, in which a fine concavo-convex structure of the fine concavo-convex structure layer has a convexity having an average height of from 80 to 500 nm or a concavity having an average depth of from 80 to 500 nm and an average interval between the convexities or the concavities is from 20 to 400 nm.

<6> A laminate film used in a touch panel device, the laminate film including:

a first transparent conductive film equipped with a first substrate, a refractive index adjusting layer provided on a first surface of the first substrate, a first transparent conductive layer provided on a surface on the opposite side to the first substrate of the refractive index adjusting layer, and a fine concavo-convex structure layer provided on a second surface of the first substrate;

a second transparent conductive film equipped with a second substrate and a second transparent conductive layer;

a transparent adhesive layer to bond the first transparent conductive film to the second transparent conductive film such that the first transparent conductive layer and the second substrate face each other; and

a peelable protective film laminated on a surface on a side having a fine concavo-convex structure of the fine concavo-convex structure layer, in which

the fine concavo-convex structure layer has a fine concavo-convex structure having an average interval between convexities or concavities of 400 nm or less on a surface and is provided on a second surface of the first substrate such that a surface on the opposite side to the surface on a side having the fine concavo-convex structure faces a first substrate side,

an air bubble having a diameter of 20 μm or more is not present in between the transparent adhesive layer and the first transparent conductive layer and between the transparent adhesive layer and the second substrate, and

an air bubble having a diameter of 20 μm or more is not present in between the fine concavo-convex structure layer and the protective film.

<7> The laminate film according to <6>, in which the refractive index adjusting layer has a laminate structure equipped with one or more layers of a high refractive index layer having a higher refractive index than the first substrate and one or more layers of a low refractive index layer having a lower refractive index than the high refractive index layer.

<8> The laminate film according to <6> or <7>, further including a hard coat layer between the first substrate and the refractive index adjusting layer.

<9> The laminate film according to any one of <6> to <8>, in which a fine concavo-convex structure of the fine concavo-convex structure layer has a convexity having an average height of from 80 to 500 nm or a concavity having an average depth of from 80 to 500 nm and an average interval between the convexities or the concavities is from 20 to 400 nm.

<10> A touch panel device used in an image display device, the touch panel device including:

a first transparent conductive film equipped with a first substrate, a refractive index adjusting layer provided on a first surface of the first substrate, a first transparent conductive layer provided on a surface on the opposite side to the first substrate of the refractive index adjusting layer, and a fine concavo-convex structure layer provided on a second surface of the first substrate;

a second transparent conductive film equipped with a second substrate and a second transparent conductive layer; and

a transparent adhesive layer to bond the first transparent conductive film to the second transparent conductive film such that the first transparent conductive layer and the second substrate face each other, in which

the fine concavo-convex structure layer has a fine concavo-convex structure having an average interval between convexities or concavities of 400 nm or less on a surface and is provided on a second surface of the first substrate such that a surface on the opposite side to the surface on a side having the fine concavo-convex structure faces a first substrate side, and

an air bubble having a diameter of 20 μm or more is not present in between the transparent adhesive layer and the first transparent conductive layer and between the transparent adhesive layer and the second substrate.

<11> The touch panel device according to <10>, in which the refractive index adjusting layer has a laminate structure equipped with one or more layers of a high refractive index layer having a higher refractive index than the first substrate and one or more layers of a low refractive index layer having a lower refractive index than the high refractive index layer.

<12> The touch panel device according to <10> or <11>, further including a hard coat layer between the first substrate and the refractive index adjusting layer.

<13> An image display device including:

an image display device main body; and

the touch panel device according to any one of <10> to <12>, in which

the touch panel device is oppositely disposed to the image display device main body via the air such that a surface on a side having a fine concavo-convex structure of the fine concavo-convex structure layer of the first transparent conductive film faces the image display device main body.

<14> A mobile device including:

the image display device according to <13>.

<15> A method for manufacturing a laminate film used in a touch panel device, in which

the laminate film is equipped with a first transparent conductive film, a second transparent conductive film, a transparent adhesive layer, and a protective film,

the first transparent conductive film is equipped with a first substrate, a refractive index adjusting layer provided on a first surface of the first substrate, a first transparent conductive layer provided on a surface on the opposite side to the first substrate of the refractive index adjusting layer, and a fine concavo-convex structure layer provided on a second surface of the first substrate, in which the fine concavo-convex structure layer has a fine concavo-convex structure having an average interval between convexities or concavities of 400 nm or less on a surface and is provided on a second surface of the first substrate such that a surface on the opposite side to the surface on a side having the fine concavo-convex structure faces a first substrate side,

the second transparent conductive film is equipped with a second substrate and a second transparent conductive layer,

a peelable protective film is laminated on a surface on a side having a fine concavo-convex structure of the fine concavo-convex structure layer, and

the first transparent conductive film and the second transparent conductive film are laminated via a transparent adhesive layer such that the first transparent conductive film and the second substrate face each other and a pressure is applied.

### Effect of the Invention

According to the invention, it is possible to provide a laminate film for a touch panel device which is excellent in resistance to blocking and resistance to Newton's rings and by which a clear image can be obtained, a touch panel device, an image display device.

In addition, according to the invention, it is possible to provide a laminate film by which air bubbles are hardly generated in between a protective film and a laminate film even when the laminate film having the protective film laminated thereon is subjected to a pressure degassing treatment and a touch panel device and an image display device which have high quality can be more simply obtained, a manufacturing method thereof, a touch panel device, an image display device, and a mobile device.

### BRIEF DESCRIPTION OF DRAWINGS

FIG. 1 is a cross-sectional diagram illustrating an example of the laminate film of a first aspect of the invention;

FIG. 2 is a block diagram illustrating an example of a manufacturing apparatus for forming a fine concavo-convex structure layer on a substrate;

FIG. 3 is a cross-sectional diagram illustrating the manufacturing process of a mold having anodized alumina on the surface;

FIG. 4 is a cross-sectional diagram illustrating another example of the laminate film of a first aspect of the invention;

FIG. 5 is a cross-sectional diagram illustrating still another example of the laminate film of a first aspect of the invention;

FIG. 6 is a cross-sectional diagram illustrating an example of the laminate film of a second aspect of the invention;

FIG. 7A is a cross-sectional diagram schematically illustrating a step of disposing a protective film on a film having a fine concavo-convex structure on the surface and conducting to a pressure treatment;

FIG. 7B is a cross-sectional diagram schematically illustrating a step of disposing a protective film on a film having a flat surface and conducting to a pressure treatment; and

FIG. 8 is a cross-sectional diagram illustrating an example of the touch panel device and the image display device of the invention.

### EMBODIMENTS FOR CARRYING OUT THE INVENTION

Hereinafter, the invention will be described in detail.

Incidentally, the term “transparent” in the present specification means to transmit light having at least a wavelength of from 400 to 1170 nm.

In addition, the term “conductive” in the present specification means that the surface resistance is 1×10³Ω/□ or less.

In addition, the term “active energy ray” in the present specification means visible light, ultraviolet light, electron beams, plasma, heat rays (infrared rays or the like), and the like.

In addition, the term “(meth)acrylic resin” in the present specification is a general term for an acrylic resin and a methacrylic resin, and the term “(meth)acrylate” is a general term for an acrylate and a methacrylate.

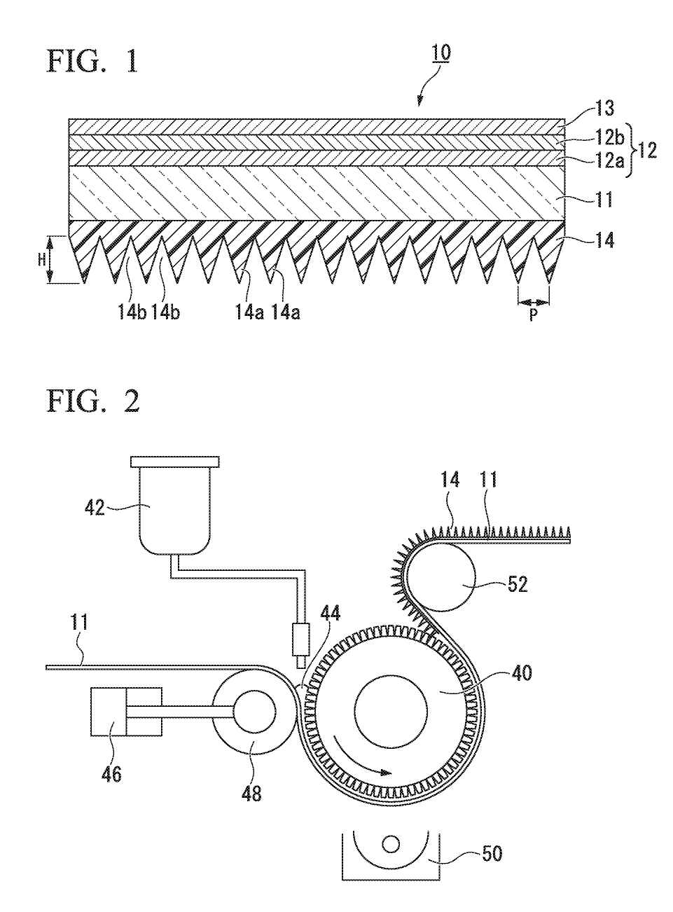

In FIG. 1, the respective layers have different reduced scales in order to have a recognizable size on the respective drawings.

In addition, in FIGS. 2, 4 to 6, and 8, the same constituents as those in FIG. 1 are denoted by the same reference numerals and the description thereon will be omitted in some cases.

“Laminate Film”

<<First Aspect>>

The laminate film of a first aspect of the invention is used in a touch panel device.

FIG. 1 is a cross-sectional diagram illustrating an example of a laminate film 10 of the first aspect of the invention.

The laminate film 10 in this example is equipped with a substrate 11, a refractive index adjusting layer 12 provided on a first surface of the substrate 11, a transparent conductive layer 13 provided on the surface on the opposite side to the substrate 11 of the refractive index adjusting layer 12, and a fine concavo-convex structure layer 14 provided on a second surface (namely, surface on the opposite side to the first surface) of the substrate 11.

<Substrate>

The substrate 11 is preferably composed of a transparent resin material. Examples of the transparent resin material may include a polyester-based resin, an acetate-based resin, a polyethersulfone-based resin, a polycarbonate-based resin, a polyamide-based resin, a polyimide-based resin, a polyolefin-based resin, a (meth)acrylic resin, a polyvinyl chloride-based resin, a polyvinylidene chloride-based resin, a polystyrene-based resin, a polyvinyl alcohol-based resin, a polyarylate-based resin, and a polyphenylene sulfide-based resin. It is preferable to use a polyethylene terephthalate (PET) substrate as the substrate 11 since it is particularly excellent in heat resistance and impact resistance.

The thickness of the substrate 11 is preferably from 2 to 200 μm. The mechanical strength of the substrate 11 is insufficient when the thickness of the substrate 11 is less than 2 μm, and thus it is difficult to conduct an operation of shaping the film-shaped substrate 11 into a roll and continuously forming the refractive index adjusting layer 12, the transparent conductive layer 13, and the fine concavo-convex structure layer 14 thereon in some cases.

<Refractive Index Adjusting Layer>

The refractive index adjusting layer 12 is provided on the first surface of the substrate 11.

The refractive index adjusting layer 12 illustrated in FIG. 1 has a laminate structure equipped with one layer of a high refractive index layer 12a and one layer of a low refractive index layer 12b in order from the substrate 11 side.

The high refractive index layer 12a is a layer having a higher refractive index than the substrate 11, and the low refractive index layer 12b is a layer having a lower refractive index than the high refractive index layer 12a.

The transparent conductive layer 13 to be described later has a higher refractive index as compared to the substrate 11 in many cases, but it is possible to suppress the reflection of light from between the transparent conductive layer 13 and the substrate 11 and to obtain a touch panel device having a high transmittance by providing the refractive index adjusting layer 12 between the substrate 11 and the transparent conductive layer 13. In addition, it is possible to suppress a change in color of light to transmit when the laminate film 10 is used in a touch panel device by appropriately setting the refractive index adjusting layer 12.

The wavelength dispersion or coloring of the reflected light or transmitted light can be defined by measuring the spectrum of the reflected light or transmitted light using a spectrophotometer or the like and determining the value of L*a*b* color system (Lab color space) from the measurement results thus obtained in conformity with JIS Z 8729 or ISO 11664-4. The L*a*b* color system corresponds to the color lightness (L*=0 is black, L*=100 is diffuse color of white, and reflected color of white is much higher), the position between red/magenta and green (a*, a negative value is closer to green and a positive value is closer to magenta), and the position between yellow and blue (b*, a negative value is closer to blue and a positive value is closer to yellow). In other words, coloring is to be smaller as the distance from the origin (L*=0, a*=0, and b*=0) of L*a*b*, namely the color difference (E*) is smaller.

In the case of using the laminate film 10 in a touch panel device, the absolute values of the a* and b* values represented by the L*a*b* color system that are determined by the following Equation (1) are preferably 2.5 or less, respectively, in the wavelength region of visible light. It is possible to sufficiently suppress coloring of the light transmitted through a touch panel device when the a* and b* values are 2.5 or less, respectively.

E*{(L*)²+(a*)²+(b*)²}^{1/2} (1)

In order to set the a* and b* values described above to be 2.5 or less, respectively, as illustrated in FIG. 1, it is preferable to configure the refractive index adjusting layer 12 by a plurality of layers having different refractive indexes and it is more preferable to laminate the high refractive index layer 12a and the low refractive index layer 12b in order from the substrate 11 side towards the transparent conductive layer 13 side.

It is preferable that the high refractive index layer 12a is specifically configured so as to have a refractive index of 1.6 or more and it is preferable that the low refractive index layer 12b is configured so as to have a refractive index of 1.45 or less. In addition, it is preferable that the high refractive index layer 12a and the low refractive index layer 12b are configured so as to have a thickness of the respective layers of from 20 to 80 nm.

It is possible to sufficiently suppress coloring of the light transmitted through a touch panel device by having such a configuration.

Examples of the material for forming the high refractive index layer 12a and the low refractive index layer 12b may include an inorganic material, an organic material, and a mixture of an inorganic material and an organic material. Examples of the inorganic material may include NaF, Na₃AlF₆, LiF, MgF₂, CaF₂, SiO₂, LaF₃, CeF₃, Al₂O₃, TiO₂, Ta₂O₅, ZrO₂, ZnO, ZnS, and SiOₓ (x is 1.5 or more and less than 2). Meanwhile, examples of the organic material may include an acrylic resin, a urethane resin, a melamine resin, an alkyd resin, and a siloxane-based polymer. In particular, it is preferable to use a thermosetting resin composed of a mixture of a melamine resin, an alkyd resin, and an organosilane condensate as the organic material.

<Transparent Conductive Layer>

The transparent conductive layer 13 is provided on the surface on the opposite side to the substrate 11 of the refractive index adjusting layer 12.

The transparent conductive layer 13 is a layer which contains a transparent conductive material.

Examples of the transparent conductive material may include an oxide (metal oxide) of at least one kind of metal selected from the group consisting of indium, tin, zinc, gallium, antimony, titanium, silicon, zirconium, magnesium, aluminum, gold, silver, copper, palladium, and tungsten; and a conductive polymer composition containing a conductive polymer and a dopant.

The metal oxide may further contain a metal atom mentioned in the above group if necessary, and for example, indium oxide (ITO) containing tin oxide, tin oxide (ATO) containing antimony, and the like are preferably used.

Examples of the conductive polymer may include poly(3,4-ethylenedioxy)thiophene (PEDOT). Meanwhile, examples of the dopant may include polystyrene sulfonic acid (PSS) and a copolymer of polystyrene sulfonic acid. The combination of PEDOT and PSS can impart high transparency and high conductivity on the transparent conductive layer 13.

The thickness of the transparent conductive layer 13 is not particularly limited, but the thickness is preferably 10 nm or more in order to form the transparent conductive layer 13 as a continuous film having a surface resistance of 1×10³Ω/□ or less so as to exhibit favorable conductivity, and it is more preferably from 15 to 35 nm and even more preferably from 20 to 30 nm. The electrical resistance of the surface tends to be higher when the thickness of the transparent conductive layer 13 is 10 nm or more, and the transparency can be favorably maintained when the thickness is 35 nm or less.

<Fine Concavo-Convex Structure Layer>

The fine concavo-convex structure layer 14 has a fine concavo-convex structure composed of the cured product of an active energy ray-curable resin composition to be described later on the surface. The fine concavo-convex structure layer 14 is provided on the second surface of the substrate 11 such that the surface on the opposite side to the surface on the side having the fine concavo-convex structure faces the substrate 11 side.

Incidentally, the surface on the side having the fine concavo-convex structure is denoted as the “surface of the fine concavo-convex structure layer” and the surface on the opposite side to the surface on the side having the fine concavo-convex structure is denoted as the “rear surface of the fine concavo-convex structure layer”.

The fine concavo-convex structure of the fine concavo-convex structure layer 14 has a so-called moth eye structure in which a plurality of the convexities (projections) 14a of a substantially conical shape, a pyramidal shape, or the like and the concavities 14b present between the convexities 14a are lined up. The moth eye structure in which an average interval between the convexities 14a or the concavities 14b is equal to or less than the wavelength of visible light, namely 400 nm or less is known to be an effective antireflective means as the refractive index in the moth eye structure continuously increases from the refractive index of the air to the refractive index of the material.

The average interval between the convexities 14a or the concavities 14b constituting the fine concavo-convex structure of the fine concavo-convex structure layer 14 is equal to or less than the wavelength of visible light, namely 400 nm or less, and it is preferably 250 nm or less and more preferably 200 nm or less. The average interval between the convexities 14a or the concavities 14b is preferably 20 nm or more from the viewpoint of ease of forming the convexity 14a.

The average interval between the convexities 14a or the concavities 14b is one that is obtained by measuring the interval (distance from the center of a convexity 14a to the center of an adjacent convexity 14a) P between adjacent convexities 14a through electron microscopic observation at 50 points and averaging these values.

The average height of the convexities 14a or the average depth of the concavities 14b is preferably from 80 to 500 nm, more preferably from 120 to 400 nm, and even more preferably from 150 to 300 nm. The reflectivity is sufficiently low and the wavelength dependence of the reflectivity decreases when the average height of the convexities 14a or the average depth of the concavities 14b is 80 nm or more, and the excoriation resistance of the convexity 14a is favorable when it is 500 nm or less.

The average height of the convexities 14a or the average depth of the concavities 14b is one that is obtained by measuring the vertical distance H between the topmost portion of the convexity 14a and the lowermost portion of the concavity 14b present between the convexities 14a when observed at a magnification of 30000 times using an electron microscope at 50 points and averaging these values.

The aspect ratio of the convexity 14a (average height of convexities 14a/average interval between convexities 14a) or the aspect ratio of the concavity 14b (average depth of concavities 14b/average interval between concavities 14b) is preferably from 0.8 to 5.0, more preferably from 1.2 to 4.0, and even more preferably from 1.5 to 3.0. The reflectivity is sufficiently low when the aspect ratio of the convexity 14a or the concavity 14b is 0.8 or more, and the excoriation resistance of the convexity 14a is favorable when it is 5.0 or less.

The shape of the convexity 14a or the concavity 14b is preferably a shape in which the cross-sectional area of the convexity 14a in the direction orthogonal to the height direction continuously increases in the depth direction from the topmost portion, that is, the cross-sectional shape in the height direction of the convexity 14a or the depth direction of the concavity 14b is a triangular shape, a trapezoidal shape, a bell shape, or the like.

<Method for Manufacturing Laminate Film>

The laminate film 10 illustrated in FIG. 1 can be manufactured, for example, in the following manner.

First, the fine concavo-convex structure layer 14 is formed on the second surface of the substrate 11. Subsequently, the refractive index adjusting layer 12 and the transparent conductive layer 13 are sequentially formed on the first surface of the substrate 11.

(Formation of Fine Concavo-Convex Structure Layer)

The fine concavo-convex structure layer 14 is formed on the second surface of the substrate 11, for example, using the manufacturing apparatus illustrated in FIG. 2 in the following manner.

First, an active energy ray-curable resin composition 44 is supplied to between a roll-shaped mold 40 having a fine concavo-convex structure on the surface and the substrate 11 to move along the surface of the roll-shaped mold 40 from a tank 42.

The substrate 11 and the active energy ray-curable resin composition 44 are nipped in between the roll-shaped mold 40 and a nip roll 48 having a nip pressure adjusted by a pneumatic cylinder 46 to uniformly spread the active energy ray-curable resin composition 44 through between the substrate 11 and the roll-shaped mold 40 and to fill it into the concavity of the fine concavo-convex structure of the roll-shaped mold 40 at the same time.

The active energy ray-curable resin composition 44 is irradiated with an active energy ray through the substrate 11 from an active energy ray irradiation apparatus 50 installed at the lower part of the roll-shaped mold 40 to cure the active energy ray-curable resin composition 44, whereby the fine concavo-convex structure layer 14 having a fine concavo-convex structure that is the fine concavo-convex structure transferred from the surface of the roll-shaped mold 40 on the surface is formed.

The substrate 11 having the fine concavo-convex structure layer 14 formed on the surface is peeled off therefrom using a peeling roll 52.

As the active energy ray irradiation apparatus 50, a high pressure mercury lamp, a metal halide lamp, and the like are preferable, and the quantity of light energy irradiated in this case is preferably from 100 to 10000 mJ/cm² as the accumulated light quantity.

The active energy ray-curable resin composition contains a polymerizable compound and a polymerization initiator.

Examples of the polymerizable compound may include a monomer having a radically polymerizable bond and/or a cationically polymerizable bond in the molecule, an oligomer, a reactive polymer, and the like.

The active energy ray-curable resin composition may contain a non-reactive polymer and an active energy ray sol-gel reactive composition.

Examples of the monomer having a radically polymerizable bond may include epoxy (meth)acrylate, urethane (meth)acrylates, polyester (meth)acrylate, polybutadiene (meth)acrylate, and silicon (meth)acrylate. These may be used singly or two or more kinds thereof may be used concurrently, or these may be monofunctional or polyfunctional.

Examples of the monomer having a cationically polymerizable bond may include a monomer having an epoxy group, an oxetanyl group, an oxazolyl group, a vinyloxy group, or the like.

Examples of the oligomer or the reactive polymer may include an unsaturated polyester such as a condensate of an unsaturated dicarboxylic acid and a polyhydric alcohol, a cationic polymerization type epoxy compound, a homopolymer or copolymer of the monomer which has a radical polymerizable bond in the side chain and is described above.

Examples of the non-reactive polymer may include an acrylic resin, a styrene resin, a polyurethane, a cellulose resin, polyvinyl butyral, a polyester, and a thermoplastic elastomer.

Examples of the active energy ray sol-gel reactive composition may include an alkoxysilane compound, and an alkyl silicate compound.

Examples of the polymerization initiator may include a polymerization initiator which generates a radical or a cation and is generally commercially available, such as a carbonyl compound, a dicarbonyl compound, acetophenone, benzoin ether, acylphosphine oxide, an amino carbonyl compound, and a halide. These may be used singly, or two or more kinds thereof may be used concurrently.

The content of the polymerization initiator is preferably from 0.1 to 10 parts by mass with respect to 100 parts by mass of the polymerizable compound. The polymerization hardly proceeds when the content of the polymerization initiator is less than 0.1 part by mass, and the fine concavo-convex structure layer is colored or the mechanical strength is lowered in some cases when it exceeds 10 parts by mass.

The active energy ray-curable resin composition may contain an antistatic agent, a mold release agent, an additive such as a fluorine compound for improving the stain resistance, fine particles, and a small amount of solvent if necessary.

(Formation of Refractive Index Adjusting Layer)

The refractive index adjusting layer 12 is formed by forming the high refractive index layer 12a on the first surface of the substrate 11 having the fine concavo-convex structure layer 14 formed on the second surface and then forming the low refractive index layer 12b on the high refractive index layer 12a.

The high refractive index layer 12a and the low refractive index layer 12b can be formed using the materials described above by a vacuum deposition method, a sputtering method, an ion plating method, and a coating method.

(Formation of Transparent Conductive Layer)

A thin film of a metal oxide is formed on the surface on the opposite side to the substrate 11 of the refractive index adjusting layer 12 and the thin film is adopted as the transparent conductive layer 13 in a case in which the transparent conductive layer 13 contains the metal oxide described above. As the method for forming a thin film of a metal oxide, a known method can be employed, and examples thereof may include a dry processes such as a vacuum deposition method, a sputtering method, or an ion plating method, and it is possible to employ an appropriate method depending on the thickness of the transparent conductive layer 13 to be required.

The transparent conductive layer 13 is formed by coating a paint containing the conductive polymer composition on the surface on the opposite side to the substrate 11 of the refractive index adjusting layer 12 in a case in which the transparent conductive layer 13 contains the conductive polymer composition described above.

It is preferable that the paint used in the formation of the transparent conductive layer 13 may contain a binder resin for the purpose of adjusting the refractive index of the transparent conductive layer 13 or enhancing the adhesive properties with the refractive index adjusting layer 12. The content of the binder resin in terms of solid content is preferably from 0.03 to 0.3 time the total solid content mass of the conductive polymer and the dopant. The refractive index of the transparent conductive layer 13 is likely to change depending on the content of the binder resin, and the refractive index tends to be higher as the content of the binder resin is higher. The refractive index, conductivity, and adhesive properties with the substrate 11 of the transparent conductive layer 13 are in a favorable balance when the content of the binder resin is within the above range.

As the binder resin, an aqueous dispersion or a water-soluble resin is preferable since the conductive polymer (for example, PEDOT) or the dopant (for example, PSS) is a water dispersible material. Specifically, a resin having an ester group or a resin having a glycidyl group is preferable, and it is possible to combine a monomer, an oligomer, and a polymer of these resins.

Examples of the resin having an ester group may include a polyethylene terephthalate aqueous dispersion, a polyethylene naphthalate aqueous dispersion, a polybutylene terephthalate aqueous dispersion, and a polybutylene naphthalate aqueous dispersion.

Examples of the resin having a glycidyl group may include epichlorohydrin polyglycidyl ether, polyethylene glycol diglycidyl ether, polypropylene glycol diglycidyl ether, trimethylolpropane polyglycidyl ether, diglycerol polyglycidyl ether, polyglycerol polyglycidyl ether, sorbitol polyglycidyl ether, and diethylene glycol diglycidyl ether.

The paint used in the formation of the transparent conductive layer 13 may contain a solvent or an additive.

As the solvent, water or a mixture of water and an alcohol is preferable. Examples of the alcohol may include methanol, ethanol, 1-propyl alcohol, and 2-propyl alcohol. These may be used singly or concurrently.

Examples of the additive may include a secondary dopant, a surfactant for stable dispersion or enhancing the wettability to the substrate, a leveling agent, and an organic solvent.

As the method for dispersing the conductive polymer and the dopant, and if necessary, a binder resin or an additive in a solvent, for example, it is possible to apply a known method such as a disk mill method, a ball mill method, or an ultrasonic dispersion method.

The viscosity of the paint used in the formation of the transparent conductive layer 13 is preferably adjusted depending on the method for coating the paint or the thickness of the transparent conductive layer 13.

As the coating method, for example, it is possible to employ a known method such as a gravure coating method, a bar coating method, a knife coating method, a roll coating method, a blade coating method, or a die coating method.

<Method for Manufacturing Roll-Shaped Mold>

The roll-shaped mold used in the formation of the fine concavo-convex structure layer 14 is not particularly limited, and examples thereof may include a mold provided with a fine concavo-convex structure by lithography or laser processing, and a mold having anodized alumina on the surface, but a mold having anodized alumina on the surface is preferable in consideration of increasing the area at a low cost. The mold having anodized alumina on the surface can be increased in area and is simply fabricated.

Anodized alumina is a porous oxide film (alumite) of aluminum and has a plurality of pores (concavities) on the surface.

The mold having anodized alumina on the surface can be manufactured, for example, through the following steps (a) to (e).

(a) a step of forming an oxide film by anodizing roll-shaped aluminum in an electrolytic solution at a constant voltage.

(b) a step of forming a pore generating point of anodization by removing at least a part of the oxide film.

(c) a step of forming an oxide film having a pore at the pore generating point by anodizing the roll-shaped aluminum again in an electrolytic solution.

(d) a step of enlarging the size of the pore by removing a part of the oxide film.

(e) a step of repeating the step (c) and the step (d).

(Step (a))

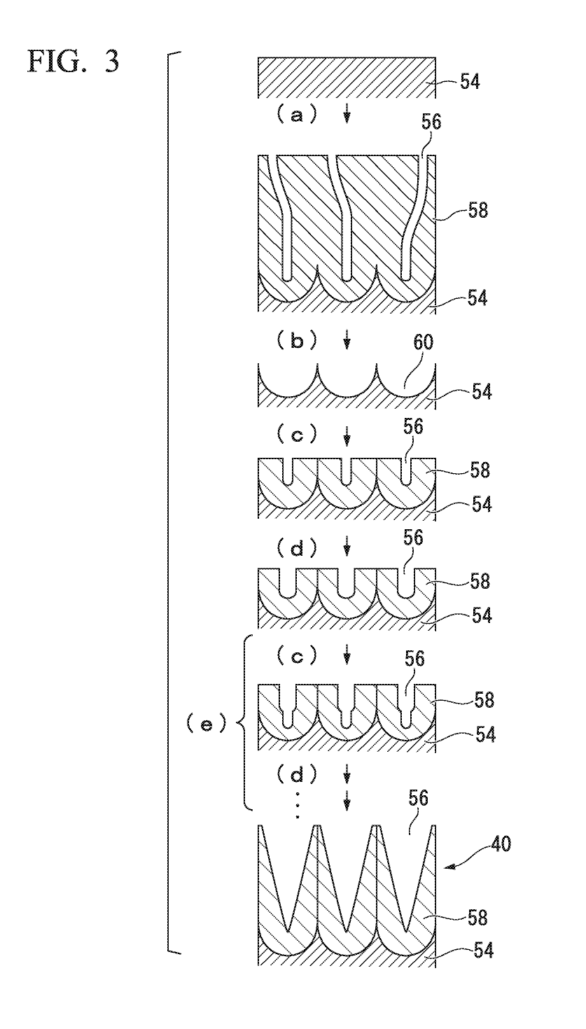

As illustrated in FIG. 3, an oxide film 58 having a pore 56 is formed when roll-shaped aluminum 54 is anodized.

The purity of aluminum is preferably 99% or higher, more preferably 99.5% or higher, and even more preferably 99.8% or higher. When the purity of aluminum is low, a concavo-convex structure having a size enough to scatter visible light by the segregation of impurities at the time of anodization is formed or the regularity of pores obtained by the anodization decreases in some cases.

Examples of the electrolytic solution may include sulfuric acid, oxalic acid, and phosphoric acid.

In the case of using oxalic acid as electrolytic solution:

The concentration of oxalic acid is preferably 0.7 M or less. The surface of the oxide film is rough in some cases as the current value increases too high when the concentration of oxalic acid exceeds 0.7 M.

It is possible to obtain anodized alumina having highly regular pores having a cycle (interval) of 100 nm when the formation voltage is from 30 to 60 V. The regularity tends to deteriorate in both cases in which the formation voltage is higher than this range and it is lower than this range.

The temperature of the electrolytic solution is preferably 60° C. or lower and more preferably 45° C. or lower. When the temperature of the electrolytic solution exceeds 60° C., a phenomenon the so-called “burning” occurs to break the pores or to destroy the regularity of pores as the surface melts in some cases.

In the case using sulfuric acid as electrolytic solution:

The concentration of sulfuric acid is preferably 0.7 M or less. It is impossible to maintain a constant voltage in some cases as the current value increases too high when the concentration of sulfuric acid exceeds 0.7 M.

It is possible to obtain anodized alumina having highly regular pores having a cycle (interval) of 63 nm when the formation voltage is from 25 to 30 V. The regularity tends to deteriorate in both cases in which the formation voltage is higher than this range and it is lower than this range.

The temperature of the electrolytic solution is preferably 30° C. or lower and more preferably 20° C. or lower. When the temperature of the electrolytic solution exceeds 30° C., a phenomenon the so-called “burning” occurs to break the pores or to destroy the regularity of pores as the surface melts in some cases.

(Step (b))

As illustrated in FIG. 3, it is possible to improve the regularity of the pores by once removing the oxide film 58 and adopting this as a pore generating point 60 of the anodization.

Examples of the method for removing the oxide film may include a method in which the oxide film is dissolved in a solution which selectively dissolves the oxide film without dissolving aluminum and then removed. Examples of such a solution may include a liquid mixture of chromic acid/phosphoric acid.

(Step (c))

As illustrated in FIG. 3, an oxide film 58 having a cylindrical pore 56 is formed when the aluminum 54 from which the oxide film has been removed is anodized again.

The anodization may be conducted under the same conditions as in the step (a). It is possible to obtain a deeper pore as the anodization time is longer.

(Step (d))

As illustrated in FIG. 3, a treatment (hereinafter, referred to as the pore size enlarging treatment) to enlarge the size of the pore 56 is conducted. The pore size enlarging treatment is a treatment to enlarge the size of the pores obtained through the anodization by immersing anodized alumina in a solution which dissolves the oxide film. Examples of such a solution may include an aqueous solution of phosphoric acid at about 5% by mass.

The pore size is greater as the anodization time is longer.

(Step (e))

As illustrated in FIG. 3, an anodized alumina having the pore 56 having a shape of which the diameter continuously decreases in the depth direction from the opening is formed when the anodization of the step (c) and the pore size enlarging treatment of the step (d) are repeated, whereby a mold (roll-shaped mold 40) having anodized alumina on the surface is obtained.

The number of repetition is preferably 3 times or more and more preferably 5 times or more in total. The diameter of the pores discontinuously decreases when the number of repetition is 2 times or less, and thus the reflectivity decreasing effect of the fine concavo-convex structure layer 14 manufactured using anodized alumina having such a pore is insufficient.

The surface of anodized alumina may be treated with a mold release agent so as to facilitate the separation from the fine concavo-convex structure layer 14. Examples of the method for this treatment may include a method to coat a silicone resin or a fluorine-containing polymer, a method to deposit a fluorine-containing compound, and a method to coat a fluorine-containing silane coupling agent or a fluorine-containing silicone-based silane coupling agent.

Examples of the shape of the pore 56 may include a substantially conical shape, a pyramidal shape, and a cylindrical shape, and a shape in which the cross-sectional area of the pore in the direction orthogonal to the depth direction continuously decreases in the depth direction from the outermost surface, such as a conical shape or a pyramidal shape is preferable.

The average interval between the pores 56 is equal to or less than the wavelength of visible light, namely 400 nm or less. The average interval between the pores 56 is preferably 20 nm or more.

The average interval between the pores 56 is one that is obtained by measuring the interval (distance from the center of a pore 56 to the center of an adjacent pore 56) between adjacent pores 56 through electron microscopic observation at 50 points and averaging these values.

The average depth of the pores 56 is preferably from 80 to 500 nm, more preferably from 120 to 400 nm, and even more preferably from 150 to 300 nm.

The average depth of the pores 56 is one that is obtained by measuring the vertical distance between the lowermost portion of the pores 56 and the topmost portion of the convexity present between the pores 56 when observed at a magnification of 30000 times using an electron microscope at 50 points and averaging these values.

The aspect ratio of the pore 56 (average depth of pores 56/average interval between pores 56) is preferably from 0.8 to 5.0, more preferably from 1.2 to 4.0, and even more preferably from 1.5 to 3.0.

The surface of the fine concavo-convex structure layer 14 formed by transferring the pores 56 as illustrated in FIG. 3 has a so-called moth eye structure.

<Effect>

In the laminate film 10 of the first aspect of the invention described above, the fine concavo-convex structure layer 14 is provided on the second surface of the substrate 11 such that the rear surface thereof faces the substrate 11 side. Although the details will be described later, the surface of the fine concavo-convex structure layer 14 faces the side on which the image of an image display device is displayed when using this laminate film 10 in a touch panel device. In other words, the touch panel device is oppositely disposed to the image display device main body via the air such that the surface of the fine concavo-convex structure layer 14 of the laminate film 10 faces the image display device main body (display element) side of the image display device to be described later. Hence, it is possible to decrease the contact area when the surface of the touch panel device is pressed and the touch panel device comes into contact with the image display device main body. As a result, it is possible to suppress the occurrence of blocking or Newton's rings in between the touch panel device and the image display device main body.

However, an air layer is present between the touch panel device and the image display device main body, and thus light is reflected from between the touch panel device and the air layer to deteriorate the visibility of the image display device in some cases.

However, the laminate film 10 of the first aspect of the invention exhibits excellent anti-reflective properties since a fine concavo-convex structure having an average interval between the convexities 14a or the concavities 14b to be equal to or less than the wavelength of visible light is formed on the surface of the fine concavo-convex structure layer 14 thereof. As described above, the touch panel device equipped with the laminate film 10 of the first aspect of the invention is disposed such that the surface of the fine concavo-convex structure layer 14 faces the image display device main body side, and thus the reflection of light from between the touch panel device and the air layer is suppressed, the visibility of the image display device is greatly improved, and a clear image can be obtained.

Moreover, the laminate film 10 of the first aspect of the invention is equipped with the refractive index adjusting layer 12, and thus the color of the light to transmit through the touch panel device hardly changes, coloring is inhibited, and haze hardly increases.

### Other Embodiments

The laminate film of the first aspect of the invention is not limited to those described above.

The refractive index adjusting layer 12 of the laminate film 10 illustrated in FIG. 1 has a laminate structure of two layers equipped with one layer of the high refractive index layer 12a and one layer of the low refractive index layer 12b, but the refractive index adjusting layer 12 may have a single layer structure or a laminate structure of three or more layers in which the high refractive index layer 12a and the low refractive index layer 12b are alternately laminated.

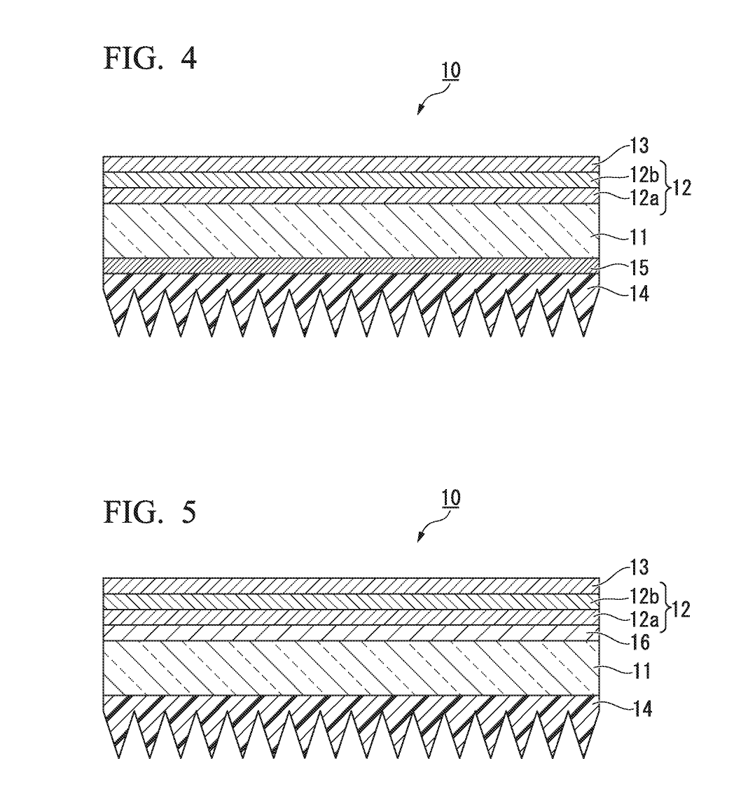

In addition, for example, as illustrated in FIG. 4, a surface modifying layer 15 may be provided on the second surface (surface on the side provided with the fine concavo-convex structure layer 14) of the substrate 11 from the viewpoint of enhancing the adhesive properties to the fine concavo-convex structure layer 14.

The surface modifying layer 15 is formed by coating a material which is appropriately prepared according to the composition of the active energy ray-curable resin composition constituting the fine concavo-convex structure layer 14 on the second surface of the substrate 11. In addition, the surface modifying layer 15 may be formed by subjecting the second surface of the substrate 11 to an etching treatment such as sputtering, corona discharge, flame, ultraviolet irradiation, electron beam irradiation, chemical conversion, or oxidation.

Incidentally, it is not required to provide the surface modifying layer 15 in a case in which the fine concavo-convex structure layer 14 is in close contact with the substrate 11.

In addition, the surface modifying layer may also be provided on the first surface of the substrate 11 (surface on the side provided with the refractive index adjusting layer 12 and the transparent conductive layer 13) if necessary. The refractive index adjusting layer 12 and the transparent conductive layer 13 are sequentially provided on the surface modifying layer in a case in which the surface modifying layer is provided on the first surface of the substrate 11. Incidentally, the surface modifying layer may be adopted as the refractive index adjusting layer 12 in a case in which the surface modifying layer has a role of refractive index adjustment.

Furthermore, as illustrated in FIG. 5, the laminate film 10 may have a hard coat layer 16 between the substrate 11 and the refractive index adjusting layer 12.

The refractive index adjusting layer 12 or the transparent conductive layer 13 is often susceptible to bending such as flexure, but it is possible to enhance the rigidity of the substrate 11 and to improve the durability of the refractive index adjusting layer 12 and the transparent conductive layer 13 by providing the hard coat layer 16. Furthermore, it can be further suppressed that the surface of the substrate 11 is degenerated by heat when forming the transparent conductive layer 13 or the haze of the laminate film 10 increases by bleed out or the like by providing the hard coat layer 16.

The hard coat layer 16 is provided on the surface modifying layer in a case in which the surface modifying layer is provided on the first surface of the substrate 11.

As the material for forming a hard coat layer 16, a material known in the prior art can be used, and examples thereof may include an ionizing radiation curable resin, a thermosetting resin, and a thermoplastic resin. In addition, the hard coat layer 16 may be formed by using the active energy ray-curable resin composition described above. In addition, from the viewpoint of further improving the strength or weather resistance of the hard coat layer 16, it is preferable to form the hard coat layer 16 by coating an alkoxysilane-based composition or a composition obtained by blending an organoalkoxysilane and colloidal silica as the main component with a curing catalyst or a solvent on one surface of the substrate 11 and drying it. As such a composition, for example, the “KP-851” and “X-12-2206” manufactured by Shin-Etsu Chemical Co., Ltd.; the “TOSGUARD 510” manufactured by Momentive Performance Materials Inc.; and the “SOLGUARD NP-720” and “SOLGUARD NP-730” manufactured by NOF METAL COATINGS GROUP, and like can be used. Examples of the method for coating the composition may include a known method such as spraying, immersion, flowing, roll coating, die coating, or gravure coating.

Incidentally, it can be further suppressed that the surface of the substrate 11 is degenerated or the haze of the laminate film 10 increases by bleed out or the like as the high refractive index layer 12a is composed of the same material as that of the hard coat layer 16, for example.

In addition, the hard coat layer 16 and the refractive index adjusting layer 12 are not separately provided as independent layers but may be provided in the form of combining the respective functions. For example, a hard coat layer having a relatively low refractive index may be provided as part of the refractive index adjusting layer or a hard coat layer having an intermediate refractive index of those of the substrate 11 and the transparent conductive layer 13 may be provided so as to also impart the function of the refractive index adjusting layer to the hard coat layer. Furthermore, the hard coat layer 16 may be a layer having a relatively high refractive index and the refractive index adjusting layer 12 may be a layer having a low refractive index.

<<Second Aspect>>

The laminate film of a second aspect of the invention is used in a touch panel device.

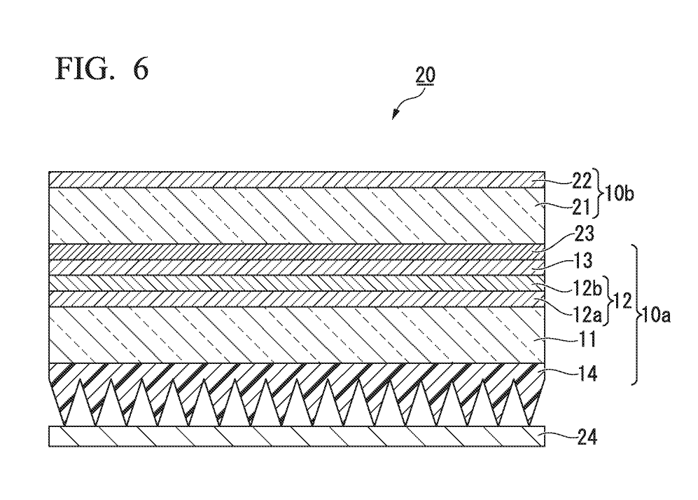

FIG. 6 is a cross-sectional diagram illustrating an example of a laminate film 20 of the second aspect of the invention.

The laminate film 20 of this example is equipped with a first transparent conductive film 10a, a second transparent conductive film 10b, a transparent adhesive layer 23, and a protective film 24.

<First Transparent Conductive Film>

The first transparent conductive film 10a is equipped with a first substrate 11, the refractive index adjusting layer 12 provided on a first surface of a first substrate 11, a first transparent conductive layer 13 provided on the surface on the opposite side to the first substrate 11 of the refractive index adjusting layer 12, and the fine concavo-convex structure layer 14 provided on the second surface of the first substrate 11.

The refractive index adjusting layer 12 illustrated in FIG. 6 has a laminate structure equipped with one layer of the high refractive index layer 12a and one layer of the low refractive index layer 12b in order from the first substrate 11 side.

The first substrate 11 corresponds to the substrate of the laminate film of the first aspect, the refractive index adjusting layer 12 corresponds to the refractive index adjusting layer of the laminate film of the first aspect, the first transparent conductive layer 13 corresponds to the transparent conductive layer of the laminate film of the first aspect, and the fine concavo-convex structure layer 14 corresponds to the fine concavo-convex structure layer of the laminate film of the first aspect. In other words, the first substrate 11, the refractive index adjusting layer 12, the first transparent conductive layer 13, and the fine concavo-convex structure layer 14 form the laminate film of the first aspect.

The fine concavo-convex structure layer 14 has a fine concavo-convex structure having an average interval between the convexities or the concavities of 400 nm or less on the surface and is provided on the second surface of the first substrate 11 such that the surface on the opposite side to the surface on the side having the fine concavo-convex structure faces the first substrate 11 side.

<Second Transparent Conductive Film>

The second transparent conductive film 10b is equipped with a second substrate 21 and a second transparent conductive layer 22.

The second substrate 21 is one which insulates the first transparent conductive layer 13 from the second transparent conductive layer 22.

The second substrate 21 is not particularly limited as long as it is formed from a material capable of insulating the first transparent conductive layer 13 from the second transparent conductive layer 22, but it is preferably formed from a transparent resin material. Examples of the transparent resin material may include the transparent resin material that has been previously exemplified in the description on the substrate of the laminate film of the first aspect.

Incidentally, it is preferable that the first substrate 11 and the second substrate 21 are formed from a transparent resin material. An image display device that is lighter and has a higher strength as compared to the case of using a glass substrate is obtained by having such a configuration.

The second transparent conductive layer 22 to be a pair together with the first transparent conductive layer 13, and in general, has a stripe-shaped electrode pattern formed thereon so as to intersect the first transparent conductive layer 13.

<Transparent Adhesive Layer>

The transparent adhesive layer 23 is one that bonds the first transparent conductive film 10a to the second transparent conductive film 10b such that the first transparent conductive layer 13 and the second substrate 21 face each other.

As the material for constituting the transparent adhesive layer 23, it is possible to use one that is known in the prior art as long as it can bond and fix the first transparent conductive film 10a and the second transparent conductive film 10b to each other, but a material which transmits light, such as an adhesive agent or a transparent resin material is preferable. Specific examples of such a material may include a rubber-based pressure sensitive adhesive agent, an acrylic pressure sensitive adhesive agent, an ethylene-vinyl acetate (EVA) copolymer-based pressure sensitive adhesive agent, a silicone-based pressure sensitive adhesive agent, a urethane-based pressure sensitive adhesive agent, a vinyl alkyl ether-based pressure sensitive adhesive agent, a polyvinyl alcohol-based pressure sensitive adhesive agent, a polyvinyl pyrrolidone-based pressure sensitive adhesive agent, a polyacrylamide-based pressure sensitive adhesive agent, and a cellulose-based pressure sensitive adhesive agent.

In addition, an adhesive sheet may be used as the transparent adhesive layer 23.

<Protective Film>

A protective film 24 is a peelable film to protect the fine concavo-convex structure of the fine concavo-convex structure layer 14 of the first transparent conductive film 10a and is laminated on the surface on the side having the fine concavo-convex structure of the fine concavo-convex structure layer 14.

As the protective film 24, those which hardly leave the adhesive residue on the fine concavo-convex structure layer 14 after being peeled off from the fine concavo-convex structure layer 14 are preferable. The protective film 24 usually has a laminate structure in which a pressure sensitive adhesive layer is laminated on a film substrate.

Examples of the film substrate may include a polyester-based resin, a nylon-based resin, a polyvinyl alcohol-based resin, a polyolefin-based resin, cellophane, polyvinylidene chloride, polystyrene, polyvinyl chloride, a polycarbonate, polymethyl methacrylate, polyurethane, a fluorocarbon resin, polyacrylonitrile, a polybutene resin, a polyimide resin, a polyarylate resin, and acetyl cellulose.

Examples of the material constituting the pressure sensitive adhesive layer may include various kinds of adhesive agents that have been previously exemplified in the description on the transparent adhesive layer 23.

In addition, a commercially available product may be used as the protective film 24. Examples of the commercially available product may include a polyolefin-based film “PAC-4-50 (trade name)” and “PET base masking SAT116 type (trade name)” manufactured by Sun A. Kaken Co., Ltd. and the “EC-2035 (trade name)” manufactured by Sumiron Co., Ltd.

<Method for Manufacturing Laminate Film>

The laminate film 20 illustrated in FIG. 6 can be manufactured, for example, in the following manner.

First, the peelable protective film 24 is laminated on the surface on the side having the fine concavo-convex structure of the fine concavo-convex structure layer 14 of the first transparent conductive film 10a. Subsequently, the first transparent conductive film 10a and the second transparent conductive film 10b are laminated via the transparent adhesive layer 23 such that the first transparent conductive layer 13 and the second substrate 21 face each other, and a pressure is applied thereto. One that is obtained by laminating at least the first transparent conductive film 10a and the second transparent conductive film 10b is also referred to as the “film laminate”.

The first transparent conductive film 10a can be manufactured by the same method as in the laminate film of the first aspect.

The second transparent conductive film 10b is manufactured by forming the second transparent conductive layer 22 on the second substrate 21. Examples of the method for forming the second transparent conductive layer 22 on the second substrate 21 may include the same method as the method for forming the transparent conductive layer on the refractive index adjusting layer in the manufacture of the laminate film of the first aspect.

(Lamination of Transparent Conductive Film)

In order to laminate the first transparent conductive film 10a and the second transparent conductive film 10b, first, the material constituting the transparent adhesive layer 23 is coated on the first transparent conductive layer 13 of the first transparent conductive film 10a to form the transparent adhesive layer 23. Subsequently, the second transparent conductive film 10b is laminated on the transparent adhesive layer 23 such that the first transparent conductive layer 13 and the second substrate 21 face each other. Thereafter, the first transparent conductive film 10a and the second transparent conductive film 10b are bonded and fixed to each other.

Incidentally, the first transparent conductive film 10a and the second transparent conductive film 10b may be laminated by disposing an adhesive sheet therebetween in the case of using an adhesive sheet as the transparent adhesive layer 23.

(Application of Pressure)

Air bubbles are likely to remain in between the transparent adhesive layer 23 and the first transparent conductive layer and between the transparent adhesive layer 23 and the second substrate by only bonding and fixing the first transparent conductive film 10a and the second transparent conductive film 10b to each other. Hence, after the first transparent conductive film 10a and the second transparent conductive film 10b are bonded and fixed to each other, the film laminate is disposed in a heat-resistant and pressure-resistant air tight container and subjected to a pressure degassing treatment by applying a pressure thereto to remove the air bubbles in between the transparent adhesive layer 23 and the first transparent conductive layer and between the transparent adhesive layer 23 and the second substrate.

The pressure applied is preferably from 0.1 to 1 MPa and more preferably from 0.2 to 0.6 MPa. It is possible to sufficiently remove the air bubbles by setting the pressure applied to 0.1 MPa or more. In addition, it is possible to more simply apply a pressure without using a special pressure container or the like by setting the pressure applied to 1 MPa or less.

(Confirmation of Air Bubbles)

It is inspected whether the air bubbles are still present in between the transparent adhesive layer 23 and the first transparent conductive layer 13 and between the transparent adhesive layer 23 and the second substrate 21, after the pressure is applied. The pressure degassing treatment is conducted by applying a pressure again in a case in which the air bubbles having a circle equivalent diameter of 20 μm or more are still present.

<Effect>

In the laminate film 20 of the second aspect of the invention described above, the fine concavo-convex structure layer 14 is provided on the second surface of the first substrate 11 such that the rear surface thereof faces the first substrate 11 side. Although the details will be described later, the surface of the fine concavo-convex structure layer 14 faces the side on which the image of an image display device is displayed when using this laminate film 20 in a touch panel device. In other words, the touch panel device is oppositely disposed to the image display device main body via the air such that the surface of the fine concavo-convex structure layer 14 of the laminate film 20 faces the image display device main body (display element) side of the image display device to be described later. Hence, it is possible to decrease the contact area when the surface of the touch panel device is pressed and the touch panel device comes into contact with the image display device main body. As a result, it is possible to suppress the occurrence of blocking or Newton's rings in between the touch panel device and the image display device main body.

In addition, the laminate film 20 of the second aspect of the invention exhibits excellent anti-reflective properties since a fine concavo-convex structure having an average interval between the convexities or the concavities to be equal to or less than the wavelength of visible light is formed on the surface of the fine concavo-convex structure layer 14 thereof. As described above, the touch panel device equipped with the laminate film 20 of the second aspect of the invention is disposed such that the surface of the fine concavo-convex structure layer 14 faces the image display device main body side, and thus the reflection of light from between the touch panel device and the air layer is suppressed, the visibility of the image display device is greatly improved, and a clear image can be obtained.

Moreover, the laminate film 20 of the second aspect of the invention is equipped with the refractive index adjusting layer 12, and thus the color of the light to transmit through the touch panel device hardly changes, coloring is inhibited, and haze hardly increases.

However, upon manufacturing the laminate film 20 of the second aspect of the invention, as described above, first, the peelable protective film 24 is laminated on the surface on the side having the fine concavo-convex structure of the fine concavo-convex structure layer 14 of the first transparent conductive film 10a. Subsequently, the first transparent conductive film 10a and the second transparent conductive film 10b are laminated via the transparent adhesive layer 23 such that the first transparent conductive layer 13 and the second substrate 21 face each other, and a pressure degassing treatment is conducted by applying a pressure to the film laminate. This makes it possible to remove the air bubbles present in between the transparent conductive films (specifically, in between the transparent adhesive layer 23 and the first transparent conductive layer 13 and between the transparent adhesive layer 23 and the second substrate 21).

There is a case in which air bubbles are generated in between the protective film and the film laminate when the pressure degassing treatment is conducted in a state in which the protective film is disposed in the case of a laminate film which does not have a fine concavo-convex structure layer.

It is difficult to inspect whether the air bubbles in between the transparent conductive films constituting the film laminate are reliably removed or not when the air bubbles are generated in between the protective film and the film laminate. For that reason, it is required to confirm the presence or absence of air bubbles in between the transparent conductive films after the protective film is once removed from the film laminate and the protective film is then disposed again in order to prevent the surface of the film laminate from being scratched in the subsequent step.

It is highly possible that the manufacturing process is complicated, and dust adheres to the surface of the film laminate, or the surface is scratched when the number of re-covering the protective film increases in this manner. Furthermore, the manufacturing cost also increases since the number of the protective film to be used in the process of manufacturing the touch panel device increases.

As a result of intensive investigation by the present inventors, it has been surprisingly found out that air bubbles are hardly generated in between the protective film and the film laminate (specifically, in between the protective film and the fine concavo-convex structure layer) even when the pressure degassing treatment is conducted after a protective film is disposed on the fine concavo-convex structure layer in a case in which a fine concavo-convex structure layer is provided on the outermost layer of the touch panel device, namely the second surface of the first substrate of the first transparent conductive film.

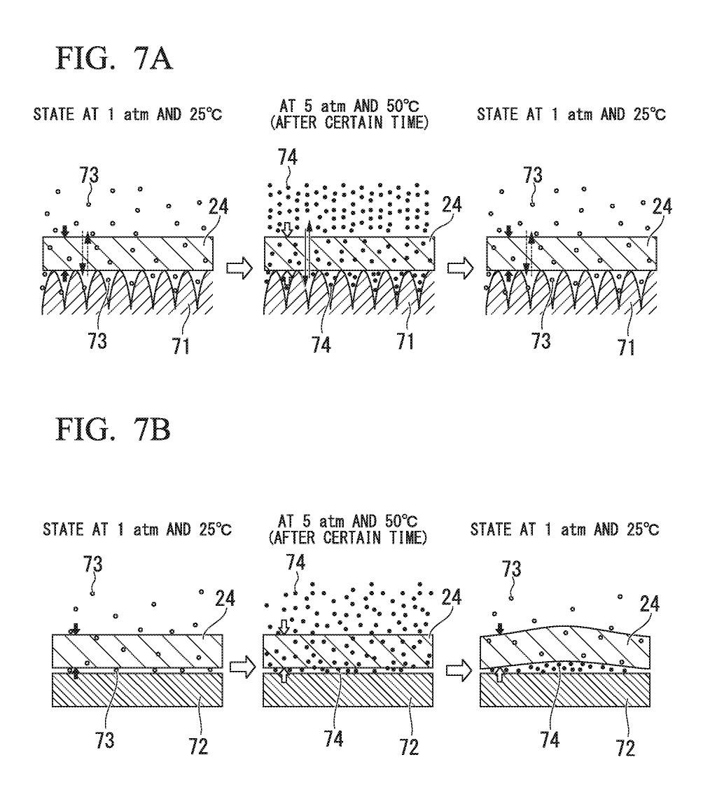

Here, the mechanism on generation of air bubbles will be described with reference to FIGS. 7A and 7B.

FIG. 7A is a cross-sectional diagram which schematically illustrates a step of disposing the protective film 24 on a film 71 having a fine concavo-convex structure on the surface and conducting a pressure treatment. Meanwhile, FIG. 7B is a cross-sectional diagram which schematically illustrates a step of disposing the protective film 24 on a film 72 having a flat surface and conducting a pressure treatment.

Incidentally, the air is represented by a particulate shape and is extremely enlarged for convenience of description. In addition, a reference numeral 73 represents the air before being pressurized, and a reference numeral 74 represents the air in a highly pressurized state.

As illustrated in FIG. 7B, although it is a significantly small amount, the air 74 in a highly pressurized state transmits through the protective film 24 and the air 74 in a highly pressurized state is interposed between the film 72 having a flat surface and the protective film 24, for example, when a pressure of about 0.5 MPa (5 atm) is applied in an environment of 50° C. in a state in which the protective film 24 is disposed on the film 72 having a flat surface. Thereafter, the air 74 that is in a highly pressurized state and interposed between the film 72 having a flat surface and the protective film 24 is left in that state when the application of pressure is terminated and the surrounding pressure is reduced, and thus air bubbles are generated in some cases.

On the other hand, as illustrated in FIG. 7A, although it is a significantly small amount, the air 74 in a highly pressurized state transmits through the protective film 24 and the air 74 in a highly pressurized state is interposed between the film 71 having a fine concavo-convex structure on the surface and the protective film 24, for example, when a pressure of about 0.5 MPa (5 atm) is applied in an environment of 50° C. in a state in which the protective film 24 is disposed on the film 71 having a fine concavo-convex structure on the surface. It is not different from the case of the film 72 having a flat surface until the air 74 in a highly pressurized state is interposed between the film 71 having a fine concavo-convex structure on the surface and the protective film 24.

However, in the case of the film 71 having a fine concavo-convex structure on the surface, the air 74 in a highly pressurized state can freely enter and exit through between the convexities of the fine concavo-convex structure, and thus the air 74 in a highly pressurized state is hardly left in between the film 71 having a fine concavo-convex structure on the surface and the protective film 24 when the pressure is reduced. For that reason, in the case of the film 71 having a fine concavo-convex structure on the surface, air bubbles are hardly generated in between the film 71 having a fine concavo-convex structure on the surface and the protective film 24 even when the application of pressure is terminated and the surrounding pressure is reduced.

Incidentally, it is also believed that it can be suppressed that the air in a highly pressurized state transmits through the protective film or the air in a highly pressurized state swells to form air bubbles by using a film exhibiting high gas barrier properties in a high pressure environment or a film having a significantly high hardness as the protective film.

However, such a special film is typically expensive, and thus it is not generally used as a protective film.

In contrast, it is possible to suppress the generation of air bubbles even in the case of using a protective film that is generally used when using a film having a fine concavo-convex structure layer.

Incidentally, the term “to suppress the generation of air bubbles” in the invention means that air bubbles having a circle equivalent diameter of 20 μm or more are not present.

As it has been described, in the second laminate film of the invention, air bubbles are hardly generated in between the protective film and the fine concavo-convex structure layer even in the case of disposing a protective film on the surface of a fine concavo-convex structure layer and conducting a treatment (pressure degassing treatment) to remove the air bubbles in between the transparent conductive films by applying a pressure. Accordingly, it is possible to confirm the presence or absence of air bubbles in between the transparent conductive films (specifically, in between the transparent adhesive layer and the first transparent conductive layer and between the transparent adhesive layer and the second substrate) without peeling off the protective film, and thus it is possible to inspect whether the air bubbles in between the transparent conductive films are removed or not without carrying out an additional step such as re-covering of the protective film. Consequently, it is possible to more simply and efficiently manufacture a laminate film used in a touch panel device.

In the second laminate film of the invention, air bubbles having a diameter of 20 μm or more are not present in between the transparent adhesive layer and the first transparent conductive layer and between the transparent adhesive layer and the second substrate, and air bubbles having a diameter of 20 μm or more are not present in between the fine concavo-convex structure layer and the protective film as well.

### Other Embodiments

The laminate film of the second aspect of the invention is not limited to those described above.

For example, the refractive index adjusting layer 12 of the first transparent conductive film 10a illustrated in FIG. 6 has a laminate structure of two layers equipped with one layer of the high refractive index layer 12a and one layer of the low refractive index layer 12b, but the refractive index adjusting layer 12 may have a single layer structure or a laminate structure of three or more layers in which the high refractive index layer 12a and the low refractive index layer 12b are alternately laminated.

In addition, the first transparent conductive film 10a illustrated in FIG. 6 may have the same configuration as the laminate film 10 illustrated in FIG. 4 or FIG. 5, for example.

“Touch Panel Device and Image Display Device”

The touch panel device of the invention is used in an image display device.

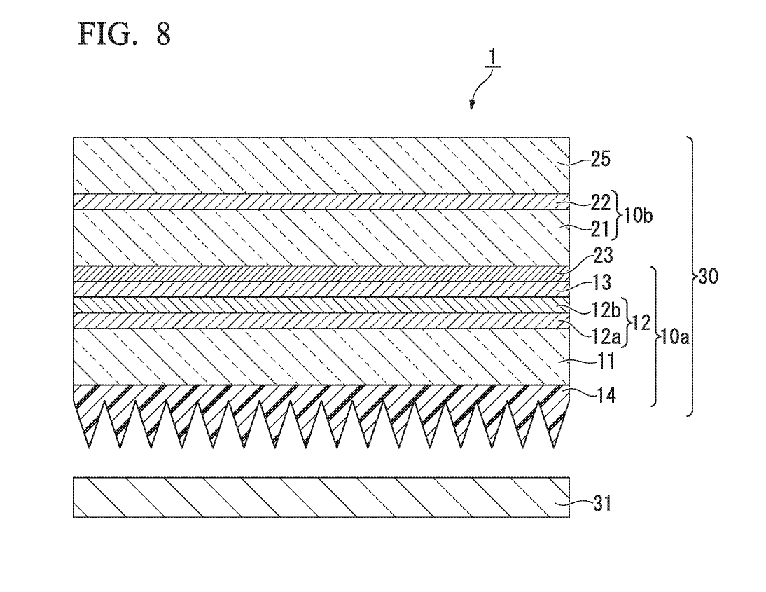

An embodiment of a touch panel device 30 of the invention and an image display device 1 having the touch panel device 30 is illustrated in FIG. 8.

<Touch Panel Device>

The touch panel device 30 illustrated in FIG. 8 is equipped with the first transparent conductive film 10a, the second transparent conductive film 10b, the transparent adhesive layer 23, and a third substrate 25.

As illustrated in FIG. 8, the touch panel device 30 is oppositely disposed to an image display device main body 31 via the air such that the surface of the fine concavo-convex structure layer 14 faces the image display device main body 31 side (namely, the side on which the image of the image display device is displayed) to form the image display device 1.

The first transparent conductive film 10a corresponds to the first transparent conductive film of the laminate film of the second aspect, the second transparent conductive film 10b corresponds to the second transparent conductive film of the laminate film of the second aspect, and the transparent adhesive layer 23 corresponds to the second transparent adhesive layer of the laminate film of the second aspect.

The fine concavo-convex structure layer 14 has a fine concavo-convex structure having an average interval between the convexities or the concavities of 400 nm or less on the surface and is provided on the second surface of the first substrate 11 such that the surface on the opposite side to the surface on the side having the fine concavo-convex structure faces the first substrate 11 side.

In addition, the refractive index adjusting layer 12 illustrated in FIG. 8 has a laminate structure equipped with one layer of the high refractive index layer 12a and one layer of the low refractive index layer 12b in order from the first substrate 11 side.

The third substrate 25 is one to protect the surface of the touch panel device 30 and the image display device 1 and is provided on the surface on the opposite side to the second substrate 21 of the second transparent conductive layer 22.

It is preferable that the third substrate 25 is constituted by a material having a high hardness.

Incidentally, it is preferable that all of the first substrate 11, the second substrate 21, and the third substrate 25 are formed from a transparent resin material. The image display device 1 that is lighter and has a higher strength as compared to the case of using a glass substrate is obtained by having such a configuration.

<Image Display Device Main Body>

Examples of the image display device main body 31 may include a display element such as a flat display panel (liquid crystal panel, an organic EL display panel, or the like).

<Method for Manufacturing Touch Panel Device and Image Display Device>

The touch panel device 30 and the image display device 1 illustrated in FIG. 8 can be manufactured, for example, in the following manner.

First, a peelable protective film is laminated on the surface on the side having the fine concavo-convex structure of the fine concavo-convex structure layer 14 of the first transparent conductive film 10a. Subsequently, the first transparent conductive film 10a and the second transparent conductive film 10b are laminated via the transparent adhesive layer 23 such that the first transparent conductive layer 13 and the second substrate 21 face each other. Furthermore, the third substrate 25 is laminated on the surface on the opposite side to the second substrate 21 of the second transparent conductive layer 22, and a pressure is then applied thereto.

The first transparent conductive film 10a can be manufactured by the same method as in the laminate film of the first aspect, and the second transparent conductive film 10b can be manufactured by the same method as the second transparent conductive film of the laminate film of the second aspect.

Examples of the protective film used in the manufacture of the touch panel device 30 may include the protective film that has been previously exemplified in the description on the laminate film of the second aspect.

In addition, the first transparent conductive film 10a and the second transparent conductive film 10b may be laminated by the same method as that in the lamination of the transparent conductive film that has been previously described in the laminate film of the second aspect.

The third substrate 25 may be laminated on the second transparent conductive layer 22 via an adhesive agent, or the third substrate 25 may be directly formed on the second transparent conductive layer 22 by supplying a transparent resin material onto the second transparent conductive layer 22 and curing this.

The method for applying a pressure is the same as the method for applying a pressure that has been previously described in the laminate film of the second aspect.

It is inspected whether the air bubbles are still present in between the transparent adhesive layer 23 and the first transparent conductive layer 13 and between the transparent adhesive layer 23 and the second substrate 21 or in between the second transparent conductive layer 22 and the third substrate 25 after the pressure is applied. The pressure degassing treatment is conducted by applying a pressure again in a case in which the air bubbles having a circle equivalent diameter of 20 μm or more are still present.

The protective film is peeled off from the fine concavo-convex structure layer 14 to obtain the touch panel device 30 illustrated in FIG. 8 in a case in which the air bubbles are not present.

The touch panel device 30 obtained in this manner is oppositely disposed to the image display device main body 31 via the air such that the surface of the fine concavo-convex structure layer 14 faces the image display device main body 31 side to obtain the image display device 1.

<Effect>

The touch panel device 30 of the present embodiment described above is oppositely disposed to the image display device main body 31 via the air such that the surface of the fine concavo-convex structure layer 14 faces the image display device main body 31 side (namely, the side on which the image of the image display device is displayed) to form the image display device 1. Hence, it is possible to decrease the contact area when the surface (surface on the third substrate 25 side) of the touch panel device 30 is pressed and the touch panel device 30 comes into contact with the image display device main body 31. As a result, it is possible to suppress the occurrence of blocking or Newton's rings in between the touch panel device 30 and the image display device main body 31.

In addition, as described above, the touch panel device 30 exhibits excellent anti-reflective properties since a fine concavo-convex structure having an average interval between the convexities or the concavities to be equal to or less than the wavelength of visible light is formed on the surface of the fine concavo-convex structure layer 14 thereof. The touch panel device 30 is disposed such that the surface of the fine concavo-convex structure layer 14 faces the image display device main body 31 side, and thus the reflection of light from between the touch panel device 30 and the air layer is suppressed, the visibility of the image display device 1 is greatly improved, and a clear image can be obtained.

Moreover, the touch panel device 30 of the present embodiment is equipped with the refractive index adjusting layer 12, and thus the color of the light to transmit through the touch panel device 30 hardly changes, coloring is inhibited, and haze hardly increases.

In addition, upon manufacturing the touch panel device 30, as described above, first, a peelable protective film is laminated on the surface on the side having the fine concavo-convex structure of the fine concavo-convex structure layer 14 of the first transparent conductive film 10a. Subsequently, the first transparent conductive film 10a and the second transparent conductive film 10b are laminated via the transparent adhesive layer 23 such that the first transparent conductive layer 13 and the second substrate 21 face each other, further the third substrate 25 is laminated on the second transparent conductive layer 22, and a pressure degassing treatment is then conducted by applying a pressure to the film laminate. This makes it possible to remove the air bubbles present in between the transparent conductive films (specifically, in between the transparent adhesive layer 23 and the first transparent conductive layer 13 and between the transparent adhesive layer 23 and the second substrate 21) or in between the second transparent conductive layer 22 and the third substrate 25.

In the touch panel device of the present embodiment, air bubbles are hardly generated in between the protective film and the fine concavo-convex structure layer even in the case of disposing a protective film on the surface of a fine concavo-convex structure layer and conducting a treatment to remove the air bubbles in between the transparent conductive films by applying a pressure. The reason for that air bubbles are hardly generated is as described in the laminate film of the second aspect.

Accordingly, it is possible to confirm the presence or absence of air bubbles in between the transparent conductive films or in between the second transparent conductive layer 22 and the third substrate 25 without peeling off the protective film, and thus it is possible to inspect whether the air bubbles in between the transparent conductive films or in between the second transparent conductive layer 22 and the third substrate 25 are removed or not without carrying out an additional step such as re-covering of the protective film. Consequently, it is possible to more simply and efficiently manufacture a touch panel device.

In the touch panel device and image display device of the present embodiment, air bubbles having a diameter of 20 μm or more are not present in between the transparent adhesive layer and the first transparent conductive layer and between the transparent adhesive layer and the second substrate. In addition, air bubbles having a diameter of 20 μm or more are not present in between the second transparent conductive layer and the third substrate as well.

### Other Embodiments

The touch panel device and image display device of the present embodiment are not limited to those described above.

For example, the refractive index adjusting layer 12 of the first transparent conductive film 10a illustrated in FIG. 8 has a laminate structure of two layers equipped with one layer of the high refractive index layer 12a and one layer of the low refractive index layer 12b, but the refractive index adjusting layer 12 may have a single layer structure or a laminate structure of three or more layers in which the high refractive index layer 12a and the low refractive index layer 12b are alternately laminated.

In addition, the first transparent conductive film 10a illustrated in FIG. 8 may have the same configuration as the laminate film 10 illustrated in FIG. 4 or FIG. 5, for example.

In addition, the third substrate 25 may be omitted.

“Mobile Device”

The mobile device of the invention is equipped with the image display device of the invention.

In the mobile device of the invention, it is possible to suppress the occurrence of blocking or Newton's rings in between the touch panel device and the image display device main body. In addition, the visibility of the image display device is greatly improved, and a clear image can be obtained. Moreover, the color of the light to transmit through the touch panel device 30 hardly changes, coloring is inhibited, and haze hardly increases.

### EXAMPLES

Hereinafter, the invention will be specifically described with reference to Examples, but the invention is not limited thereto.

<Measurement of Pores of Anodized Alumina>

A part of anodized alumina was scraped, platinum was deposited on the cross-section thereof for 1 minute, and the cross-section thereof was observed under a condition of an acceleration voltage of 3.00 kV using a field emission scanning electron microscope (“JSM-7400F” manufactured by JEOL Ltd.) to measure the interval between the pores and the depth of the pore. The measurement was conducted at 50 points for each, and the average values thereof were determined.

<Measurement of Convexity of Fine Concavo-Convex Structure Layer>

Platinum was deposited on the fracture surface of the fine concavo-convex structure layer for 10 minutes, the cross-section thereof was observed in the same manner as in anodized alumina to measure the interval between the convexities and the height of the convexity. The measurement was conducted at 50 points for each, and the average values thereof were determined.

<Measurement of Transmittance>

The transmittance of the laminate film was measured in conformity with JIS K 7136: 2000 (ISO 14782: 1999) using a haze meter (manufactured by Suga Test Instruments Co., Ltd.) and by taking a fine concavo-convex structure side as a light source side.

<Measurement of Haze>

The haze of the laminate film was measured in conformity with JIS K 7136: 2000 (ISO 14782: 1999) using a haze meter (manufactured by Suga Test Instruments Co., Ltd.) and by taking the fine concavo-convex structure side as the light source side.

<Measurement of Color Difference>

The spectrum of the transmitted light in the wavelength region of visible light in the light transmitted through the laminate film was measured using a spectrophotometer UV-2450 (manufactured by SHIMADZU CORPORATION), the values of a* and b* were determined from the measurement results in conformity with JIS Z 8729 (ISO 11664-4).

<Manufacture of Roll-Shaped Mold>

A roll composed of aluminum having a purity of 99.99% was subjected to electrolytic polishing in a mixed solution of perchloric acid/ethanol (1/4 volume ratio).

### Step (a):

The role was subjected to anodization in a 0.5 M aqueous solution of oxalic acid for 6 hours under the conditions having a direct current of 40 V and a temperature of 16° C.

### Step (b):

The roll having an oxide film formed thereon was immersed in a mixed aqueous solution of phosphoric acid at 6% by mass and chromic acid at 1.8% by mass for 6 hours to remove at least a part of the oxide film.

### Step (c):

The role was subjected to anodization in a 0.3 M aqueous solution of oxalic acid for 45 seconds under the conditions having a direct current of 40 V and a temperature of 16° C.

### Step (d):

The roll having an oxide film formed thereon was immersed in phosphoric acid at 5% by mass and 32° C. for 8 minutes to remove a part of the oxide film, thereby conducting the pore size enlarging treatment.

### Step (e):

The step (c) and the step (d) were repeated 5 times in total, thereby obtaining a roll-shaped mold a in which anodized alumina having a pore having an average interval: 100 nm, an average depth: 150 nm, and a substantially conical shape was formed on the surface.

The roll-shaped mold a thus obtained was immersed in a dilute solution of OPTOOL DSX (manufactured by Daikin Industries, Ltd.) at 0.1% by mass and air-dried for the night, thereby conducting the fluorination treatment of the oxide film surface.

<Preparation of Active Energy Ray-Curable Resin Composition>

45 parts by mass of a condensation reaction mixture of succinic acid/trimethylolethane/acrylic acid in a molar ratio of 1:2:4,

45 parts by mass of 1,6-hexanediol diacrylate (manufactured by Osaka Organic Chemical Industry Ltd.),

10 parts by mass of radical polymerizable silicone oil (“X-22-1602” manufactured by Shin-Etsu Chemical Co., Ltd.),

3 parts by mass of 1-hydroxycyclohexyl phenyl ketone (“IRGACURE 184” manufactured by Ciba Specialty Chemicals), and

0.2 part by mass of bis(2,4,6-trimethylbenzoyl)-phenylphosphine oxide (“IRGACURE 819” manufactured by Ciba Specialty Chemicals),

were mixed together, thereby obtaining an active energy ray-curable resin composition A.

<Preparation of Resin Composition for High Refractive Index Layer>

11.0 parts by mass of a methyl ethyl ketone dispersion of ZrO₂ fine particles (“MZ-230X” manufactured by Sumitomo Osaka Cement Co., Ltd., solid content concentration: 30% by mass) as a high refractive index fine particle dispersion,

1.6 parts by mass of pentaerythritol triacrylate (“KAYARAD-PET-30” manufactured by Nippon Kayaku Co., Ltd.),

87.3 parts by mass of methyl isobutyl ketone, and

0.1 part by mass of 2-hydroxy-1-{4-[4-(2-hydroxy-2-methyl-propionyl)-benzyl]-phenyl}-2-methyl-propan-1-one (“IRGACURE 127” manufactured by BASF) were mixed together, thereby obtaining a resin composition for high refractive index layer (composition for high refractive index layer).

<Preparation of Resin Composition for Low Refractive Index Layer>

0.6 part by mass of pentaerythritol triacrylate (“KAYARAD-PET-30” manufactured by Nippon Kayaku Co., Ltd.),

2.2 parts by mass of a fluorine monomer (“LINC-3A” manufactured by Kyoeisha Chemical Co., Ltd.),

97.0 parts by mass of methyl isobutyl ketone, and

0.2 part by mass of 2-hydroxy-1-{4-[4-(2-hydroxy-2-methyl-propionyl)-benzyl]-phenyl}-2-methyl-propan-1-one (“IRGACURE 127” manufactured by BASF)

were mixed together, thereby obtaining a resin composition for low refractive index layer (composition for low refractive index layer).

### Example 1

### Formation of Fine Concavo-Convex Structure Layer

The roll-shaped mold a subjected to the fluorination treatment was installed to the manufacturing apparatus illustrated in FIG. 2, the active energy ray-curable resin composition A was supplied to the tank 42, a PET substrate was used as the substrate 11, and the fine concavo-convex structure layer 14 was formed on the substrate 11 in the following manner.

First, the active energy ray-curable resin composition 44 was supplied to between the roll-shaped mold 40 having a fine concavo-convex structure on the surface and the substrate 11 to move along the surface of the roll-shaped mold 40 from the tank 42.

The substrate 11 and the active energy ray-curable resin composition 44 were nipped in between the roll-shaped mold 40 and the nip roll 48 having a nip pressure adjusted by the pneumatic cylinder 46 to uniformly spread the active energy ray-curable resin composition 44 through between the substrate 11 and the roll-shaped mold 40 and to fill it into the concavity of the fine concavo-convex structure of the roll-shaped mold 40 at the same time.

The active energy ray-curable resin composition 44 was irradiated with ultraviolet light through the substrate 11 from the active energy ray irradiation apparatus 50 installed at the lower part of the roll-shaped mold 40 in an accumulated light quantity of 3200 mJ/cm² to cure the active energy ray-curable resin composition 44, thereby forming the fine concavo-convex structure layer 14 having a fine concavo-convex structure that was the fine concavo-convex structure transferred from the surface of the roll-shaped mold 40 on the surface.

The substrate 11 having the fine concavo-convex structure layer 14 formed on the second surface was peeled off therefrom using the peeling roll 52.

The average interval between the convexities of the fine concavo-convex structure layer 14 was 100 nm, and the average height of the convexities was 150 nm.

<Formation of Refractive Index Adjusting Layer>

The composition for high refractive index layer was coated on the other surface (first surface) of the substrate 11 having the fine concavo-convex structure layer 14 formed thereon using a bar coater and dried for 1 minute at 70° C. to remove the solvent therefrom, thereby forming a coating film. The coating film was irradiated with ultraviolet light using an ultraviolet irradiating apparatus (“H bulb” manufactured by Heraeus K. K. Noblelight Division) in an irradiation quantity of 150 mJ/cm² to form a cured resin layer having a film thickness of 6.0 μm after drying and curing, thereby forming a high refractive index layer which also had the function as a hard coat layer.

Subsequently, the composition for low refractive index layer was coated on the high refractive index layer using a bar coater to form a coating film. The coating film was dried for 1 minute at 60° C. to remove the solvent, and the coating film was then irradiated with ultraviolet light using an ultraviolet irradiating apparatus (“H bulb” manufactured by Heraeus K. K. Noblelight Division) in an irradiation quantity of 100 mJ/cm² to form a low refractive index layer having a film thickness of 45 nm after drying and curing. The high refractive index layer and low refractive index layer thus formed were together adopted as the refractive index adjusting layer.

Incidentally, the refractive index of the high refractive index layer was 1.65, and the refractive index of the low refractive index layer was 1.46.

<Formation of Transparent Conductive Layer>

A thin film of a metal oxide composed of ITO having a thickness of 25 nm was formed on the surface on the opposite side to the substrate of the refractive index adjusting layer by a sputtering method, and this was adopted as a transparent conductive layer. In this manner, the laminate film 10 as illustrated in FIG. 1 was obtained in which the refractive index adjusting layer 12 consisting of the high refractive index layer 12a and the low refractive index layer 12b and the transparent conductive layer of ITO 13 were provided on the first surface of the PET substrate as the substrate 11 and the fine concavo-convex structure layer 14 was provided on the second surface.

<Patterning of ITO Film by Etching>

A protective film was laminated on the surface on the side having the fine concavo-convex structure of the fine concavo-convex structure layer 14 of the laminate film 10 thus obtained. Subsequently, a photoresist patterned into a stripe shape was coated on the transparent conductive layer 13, dried, and cured, and the resultant was then immersed in 5% hydrochloric acid (aqueous solution of hydrogen chloride) at 25° C. for 1 minute to etch the ITO film. Thereafter, the photoresist was removed.

<Crystallization of Transparent Conductor Layer by Annealing Treatment>

After being patterned, the ITO film was subjected to the heat treatment for 90 minutes at 140° C. to crystallize the ITO film.

The laminate film 10 having a patterned electrode was obtained in this manner.

For the laminate film 10 thus obtained, the transmittance of light, the haze, and the color difference were measured. The results are described in Table 1.

<Pressure Degassing Treatment>

An optical transparent pressure sensitive adhesive sheet (“CLEARFIT” manufactured by Mitsubishi Plastics, Inc.) was disposed between the laminate film 10 having a protective film laminated thereon and a glass substrate, the resultant was disposed in an autoclave, bonded, and fixed. Thereafter, the resultant was disposed in an environment having a pressure of 0.5 MPa and a temperature of 50° C. for 10 minutes, thereby subjecting the laminate film 10 and the glass substrate to the pressure degassing treatment.

The laminate of the laminate film 10 and a glass substrate thus obtained was visually observed, and air bubbles were not confirmed in between the protective film and the laminate film 10. In addition, the observation was conducted in the same manner using a microscope, and air bubbles having a circle equivalent diameter of 20 μm or more were not observed. The results thereof are described in Table 1. In addition, and air bubbles having a circle equivalent diameter of 20 μm or more were not confirmed in between the laminate film 10 and the glass substrate as well.

In addition, the protective film was peeled off from the laminate of the laminate film 10 and a glass substrate thus obtained, this was brought into close contact with the liquid crystal surface such that the fine concavo-convex structure layer 14 faced the liquid crystal surface side, the appearance thereof was visually observed through the glass substrate side, and the Newton's rings and blocking were not confirmed. In addition, a clear image was obtained when the liquid crystal was lighted up in a state in which the laminate film 10 was in close contact with the liquid crystal surface.

### Comparative Example 1

A laminate film in which the refractive index adjusting layer and the transparent conductive layer were provided on the first surface of a PET substrate and which had a patterned electrode was obtained by forming the refractive index adjusting layer and the transparent conductive layer, and conducting patterning of the ITO film by etching, and conducting crystallization of the transparent conductor layer by the annealing treatment in the same manner as in Example 1 except that a fine concavo-convex structure layer was not formed. Incidentally, the protective film was laminated on the second surface of the PET substrate.

For the laminate film thus obtained, the transmittance of light, the haze, and the color difference were measured. The results are described in Table 1.

In addition, in the same manner as in Example 1, a glass substrate was laminated on the laminate film thus obtained, the resultant was subjected to the pressure degassing treatment, and the presence or absence of air bubbles (diameter of 20 μm or more) in between the protective film and the laminate film was confirmed. The results are described in Table 1.

Furthermore, the protective film was peeled off from the laminate of a laminate film and a glass substrate thus obtained, this was brought into close contact with the liquid crystal surface such that the second surface of the PET substrate faced the liquid crystal surface side, the appearance thereof was visually observed through the glass substrate, and the Newton's rings were confirmed. In addition, the image when the liquid crystal was lighted up in a state in which the laminate film was in close contact with the liquid crystal surface was unclear.

### Comparative Example 2

A laminate film in which a fine concavo-convex structure layer was provided on the second surface of the PET substrate and the transparent conductive layer was provided on the first surface of the PET substrate and which had a patterned electrode was obtained by forming the fine concavo-convex structure layer and the transparent conductive layer, and conducting patterning of the ITO film by etching, and conducting crystallization of the transparent conductor layer by the annealing treatment in the same manner as in Example 1 except that the refractive index adjusting layer was not formed.

For the laminate film thus obtained, the transmittance of light, the haze, and the color difference were measured. The results are described in Table 1.

In addition, in the same manner as in Example 1, a glass substrate was laminated on the laminate film thus obtained, the resultant was subjected to the pressure degassing treatment, and the presence or absence of air bubbles (diameter of 20 μm or more) in between the protective film and the laminate film was confirmed. The results are described in Table 1.

Furthermore, the protective film was peeled off from the laminate of a laminate film and a glass substrate thus obtained, this was brought into close contact with the liquid crystal surface such that the second surface of the PET substrate faced the liquid crystal surface side, the appearance thereof was visually observed through the glass substrate, and the Newton's rings and blocking were not confirmed. However, the image when the liquid crystal was lighted up in a state in which the laminate film was in close contact with the liquid crystal surface was unclear.

TABLE 1

| | Presence or absence of | Presence or absence | Presence or absence of | | | | | Presence or |
|---|---|---|---|---|---|---|---|---|
| | high refractive index | of low refractive | fine concavo-convex | Transmit- | | | Haze | absence of |
| | layer | index layer | structure layer | tance [%] | a* | b* | [%] | air bubbles |
| Example 1 | Presence | Presence | Presence | 94 | −0.5 | 1.6 | 0.4 | Absence |
| Comparative | Presence | Presence | Absence | 89 | −0.4 | 1.3 | 0.5 | Presence |
| Example 1 | | | | | | | | |
| Comparative | Absence | Absence | Presence | 92 | 2.5 | 3.0 | 2.0 | Absence |
| Example 2 | | | | | | | | |

As apparent from the results in Table 1, the laminate film of Example 1 was excellent in resistance to blocking and resistance to Newton's rings. In addition, a clear image was obtained when the liquid crystal was lighted up in a state in which the laminate film was in close contact with the liquid crystal surface. In addition, the laminate film of Example 1 had a high transmittance, the values of a* and b* were 2.5 or less, respectively, and it was possible to sufficiently suppress coloring of the light transmitted through the touch panel device. In addition, the haze was low. Moreover, air bubbles having a diameter of 20 μm or more were not present in between the protective film and the laminate film after the pressure degassing treatment.

On the other hand, Newton's rings were confirmed in the laminate film of Comparative Example 1 which did not have a fine concavo-convex structure layer. In addition, the image when the liquid crystal was lighted up in a state in which the laminate film was in close contact with the liquid crystal surface was unclear. In addition, the laminate film of Comparative Example 1 had a low transmittance. In addition, air bubbles having a diameter of 20 μm or more were present in between the protective film and the laminate film after the pressure degassing treatment.

In the laminate film of Comparative Example 2 which did not have a refractive index adjusting layer, the value of b* was 3.0 and it was not possible to sufficiently suppress coloring of the light transmitted through the touch panel device. In addition, the image when the liquid crystal was lighted up in a state in which the laminate film was in close contact with the liquid crystal surface was unclear perhaps since the haze was high although the Newton's rings and blocking were not confirmed.

### INDUSTRIAL APPLICABILITY

The laminate film of the invention is useful as a member of a touch panel device.

### EXPLANATIONS OF LETTERS OR NUMERALS

1 Image display device
10 Laminate film
10a First transparent conductive film
10b Second transparent conductive film
11 Substrate (first substrate)
12 Refractive index adjusting layer
12a High refractive index layer
12b Low refractive index layer
13 Transparent conductive layer (first transparent conductive layer)
14 Fine concavo-convex structure layer
14a Convexity
14b Concavity
15 Surface modifying layer
16 Hard coat layer
20 Laminate film
21 Second substrate
22 Second transparent conductive layer
23 Transparent adhesive layer
24 Protective film
25 Third substrate
30 Touch panel device
31 Image display device main body
40 Roll-shaped mold
42 Tank
44 Active energy ray-curable resin composition
46 Pneumatic cylinder
48 Nip roll
50 Active energy ray irradiation apparatus
52 Peeling roll
54 Aluminum
56 Pore
58 Oxide film
60 Pore generating point
71 Film having fine concavo-convex structure
72 Film having flat surface
73 Air before being pressurized
74 Air in highly pressurized state

1. A laminate film used in a touch panel device, the laminate film comprising:
a substrate;
a refractive index adjusting layer provided on a first surface of the substrate;
a transparent conductive layer provided on a surface on the opposite side to the substrate of the refractive index adjusting layer; and
a fine concavo-convex structure layer provided on a second surface of the substrate, wherein
the fine concavo-convex structure layer has a fine concavo-convex structure having an average interval between convexities or concavities of 400 nm or less on a surface and is provided on the second surface of the substrate such that a surface on the opposite side to the surface on a side having the fine concavo-convex structure faces a substrate side.

2. The laminate film according to claim 1, wherein the substrate is a polyethylene terephthalate substrate.

3. The laminate film according to claim 1, wherein the refractive index adjusting layer has a laminate structure equipped with one or more layers of a high refractive index layer having a higher refractive index than the substrate and one or more layers of a low refractive index layer having a lower refractive index than the high refractive index layer.

4. The laminate film according to claim 1, further comprising a hard coat layer between the substrate and the refractive index adjusting layer.

5. The laminate film according to claim 1, wherein a fine concavo-convex structure of the fine concavo-convex structure layer has a convexity having an average height of from 80 to 500 nm or a concavity having an average depth of from 80 to 500 nm and an average interval between the convexities or the concavities is from 20 to 400 nm.

6. A laminate film used in a touch panel device, the laminate film comprising:
a first transparent conductive film equipped with a first substrate, a refractive index adjusting layer provided on a first surface of the first substrate, a first transparent conductive layer provided on a surface on the opposite side to the first substrate of the refractive index adjusting layer, and a fine concavo-convex structure layer provided on a second surface of the first substrate;
a second transparent conductive film equipped with a second substrate and a second transparent conductive layer;
a transparent adhesive layer to bond the first transparent conductive film to the second transparent conductive film such that the first transparent conductive layer and the second substrate face each other; and
a peelable protective film laminated on a surface on a side having a fine concavo-convex structure of the fine concavo-convex structure layer, wherein
the fine concavo-convex structure layer has a fine concavo-convex structure having an average interval between convexities or concavities of 400 nm or less on a surface and is provided on a second surface of the first substrate such that a surface on the opposite side to the surface on a side having the fine concavo-convex structure faces a first substrate side,
an air bubble having a diameter of 20 μm or more is not present in between the transparent adhesive layer and the first transparent conductive layer and between the transparent adhesive layer and the second substrate, and
an air bubble having a diameter of 20 μm or more is not present in between the fine concavo-convex structure layer and the protective film.

7. The laminate film according to claim 6, wherein the refractive index adjusting layer has a laminate structure equipped with one or more layers of a high refractive index layer having a higher refractive index than the first substrate and one or more layers of a low refractive index layer having a lower refractive index than the high refractive index layer.

8. The laminate film according to claim 6, further comprising a hard coat layer between the first substrate and the refractive index adjusting layer.

9. The laminate film according to claim 6, wherein a fine concavo-convex structure of the fine concavo-convex structure layer has a convexity having an average height of from 80 to 500 nm or a concavity having an average depth of from 80 to 500 nm and an average interval between the convexities or the concavities is from 20 to 400 nm.

10. A touch panel device used in an image display device, the touch panel device comprising:
a first transparent conductive film equipped with a first substrate, a refractive index adjusting layer provided on a first surface of the first substrate, a first transparent conductive layer provided on a surface on the opposite side to the first substrate of the refractive index adjusting layer, and a fine concavo-convex structure layer provided on a second surface of the first substrate;
a second transparent conductive film equipped with a second substrate and a second transparent conductive layer; and
a transparent adhesive layer to bond the first transparent conductive film to the second transparent conductive film such that the first transparent conductive layer and the second substrate face each other, wherein
the fine concavo-convex structure layer has a fine concavo-convex structure having an average interval between convexities or concavities of 400 nm or less on a surface and is provided on a second surface of the first substrate such that a surface on the opposite side to the surface on a side having the fine concavo-convex structure faces a first substrate side, and
an air bubble having a diameter of 20 μm or more is not present in between the transparent adhesive layer and the first transparent conductive layer and between the transparent adhesive layer and the second substrate.

11. The touch panel device according to claim 10, wherein the refractive index adjusting layer has a laminate structure equipped with one or more layers of a high refractive index layer having a higher refractive index than the first substrate and one or more layers of a low refractive index layer having a lower refractive index than the high refractive index layer.

12. The touch panel device according to claim 10, further comprising a hard coat layer between the first substrate and the refractive index adjusting layer.

13. An image display device comprising:
an image display device main body; and
the touch panel device according to claim 10, wherein
the touch panel device is oppositely disposed to the image display device main body via the air such that a surface on a side having a fine concavo-convex structure of the fine concavo-convex structure layer of the first transparent conductive film faces the image display device main body.

14. A mobile device comprising:
the image display device according to claim 13.

15. A method for manufacturing a laminate film used in a touch panel device, wherein
the laminate film is equipped with a first transparent conductive film, a second transparent conductive film, a transparent adhesive layer, and a protective film,
the first transparent conductive film is equipped with a first substrate, a refractive index adjusting layer provided on a first surface of the first substrate, a first transparent conductive layer provided on a surface on the opposite side to the first substrate of the refractive index adjusting layer, and a fine concavo-convex structure layer provided on a second surface of the first substrate, wherein the fine concavo-convex structure layer has a fine concavo-convex structure having an average interval between convexities or concavities of 400 nm or less on a surface and is provided on a second surface of the first substrate such that a surface on the opposite side to the surface on a side having the fine concavo-convex structure faces a first substrate side,
the second transparent conductive film is equipped with a second substrate and a second transparent conductive layer,
a peelable protective film is laminated on a surface on a side having a fine concavo-convex structure of the fine concavo-convex structure layer, and
the first transparent conductive film and the second transparent conductive film are laminated via a transparent adhesive layer such that the first transparent conductive film and the second substrate face each other and a pressure is applied.
